(19) United States
(12) Patent Application Publication
(10) Pub. No.: US 2009/0009601 A1
(43) Pub. Date: Jan. 8, 2009

(54) LOGISTICS MONITORING AND TRACKING METHOD AND SYSTEM

(76) Inventor: Ke LI, Shanghai (CN)

Correspondence Address: MATTHIAS SCHOLL, 14781 MEMORIAL DRIVE, SUITE 1319, HOUSTON, TX, 77079, US

(21) Appl. No.: 12/234,623

(22) Filed: Sep. 20, 2008

Related U.S. Application Data
(63) Continuation of application No. PCT/CN2007/000675, filed on Mar. 2, 2007.

(30) Foreign Application Priority Data
Mar. 27, 2006 (CN) 200610025130.6

(51) Int. Cl. H04N 7/18

(52) U.S. Cl. 348/143; 348/E07.085

(57) ABSTRACT

A system for monitoring objects comprising an electronic tag reading apparatus for reading an electronic tag and collecting information contained in the electronic tag; a video image monitoring apparatus for video recording an object comprising the electronic tag; and an electronic tag video image coder for integrating information contained in the electronic tag with the video recording and coding to form an integrated video image. A method for monitoring objects comprising the steps of: a) video recording an object to form a video recording of the object, the object comprising an electronic tag; b) reading the electronic tag and collecting information contained in the electronic tag; c) integrating information contained in the electronic tag with the video recording and coding to form an integrated video image; and d) digitally-storing the integrated video image.

### CROSS-REFERENCE TO RELATED APPLICATIONS

This application is a continuation of International Patent Application No. PCT/CN2007/000675 with an international filing date of Mar. 2, 2007, designating the United States, now pending, and further claims priority benefits to Chinese Patent Application No. 200610025130.6 filed Mar. 27, 2006. The contents of all of the aforementioned applications, including any intervening amendments thereto, are incorporated herein by reference.

### BACKGROUND OF THE INVENTION

1. Field of the Invention

The invention relates to a digital video-based information inquiry system and methods, and more specifically, to a logistics monitoring and tracking system having electronic tag video recording capability and methods for monitoring and tracking objects having electronic tags.

2. Description of the Related Art

Logistics management is crucial to modern society and has a major impact on society's standard of living. Progressively more people are dependent on logistics and there is constantly increasing requirement on the safety and timeliness of flow and storage of goods.

However, in existing logistics processes, loss of goods is common. Even for large international logistics enterprises having respectable management level, such as DHL, FedEx, UPS, EMS, etc, loss of goods is frequent. Loss of goods during onboard consignment is particularly serious in places such as airports, train stations, ports, etc. Statistics show that every year the loss of goods during logistics processes causes economic losses in excess of 4 billion dollars.

In order to reduce or eliminate this loss, well-developed international logistics enterprises commonly adopted barcode technology to track and monitor goods in recent years. Some technically-superior enterprises even went so far as to use RFID technology or TV monitoring technology.

However, these conventional monitoring technologies and methods have the following drawbacks.

1) The status of goods flow is not reflected or accessible in real time.

2) A video image of goods having barcodes or RFID is not recorded or monitored.

3) A video image of goods is not obtained at the same time when barcode or RFID information is obtained.

4) Existing technologies suffer from slow processing speed, high manufacturing cost, and high environmental requirements.

According, much opportunity for improvement remains in this area of logistics.

### SUMMARY OF THE INVENTION

Therefore, it is one objective of the invention to eliminate or reduce the drawbacks and problems of the existing technology and, by combining digital recording technology with electronic coding technology, to provide a logistics monitoring and tracking method and system with electronic tag video recording capability having the advantages of easy installation, low cost, and convenient operation.

In order to realize the above objective, the logistics monitoring and tracking method and system with electronic tag video recording capability of the invention comprises the steps of:

1) video recording an object to form a video recording of the object, the object comprising an electronic tag;

2) reading the electronic tag and collecting information contained in the electronic tag;

3) integrating information contained in the electronic tag with the video recording and coding to form an integrated video image; and

4) digitally-storing the integrated video image.

In a class of this embodiment or in another embodiment, the logistics monitoring and tracking method and system with electronic tag video recording capability of the invention comprises at least one electronic tag reading apparatus for reading an electronic tag and collecting information contained in the electronic tag; at least one video image monitoring apparatus for video recording an object comprising the electronic tag; and at least one electronic tag video image coder for integrating information contained in the electronic tag with the video recording and coding to form an integrated video image.

In a class of this embodiment or in another embodiment, the electronic tag reading apparatus, the video image monitoring apparatus, and the electronic tag video image coder are electrically or electronically connected.

In a class of this embodiment or in another embodiment, the system further comprises an electronic tag video image decoding management apparatus for automatically receiving multi-channel video images having electronic tag information output from the coders and storing automatically the electronic tag information; the electronic tag video image decoding management apparatus being electrically or electronically connected to the electronic tag video image coder.

In a class of this embodiment or in another embodiment, the electronic tag video image decoding management apparatus has the function of sending video images and electronic tags to a digital video image information storage server for recording and storage.

In a class of this embodiment or in another embodiment, the system further comprises a digital video image information storage server for real-time storing multi-channel video image information having electronic tags, and for inquiring and replaying a corresponding video information by inputting the electronic tag information via local or network servers; the digital video image information storage server being electrically or electronically connected with the electronic tag video image decoding management apparatus.

In another class of this embodiment or in another embodiment, the system further comprises a digital video image information storage server connected with the electronic tag video image decoding management apparatus, serving to real-time store multi-channel video image information having electronic tags, and to inquire and replay the corresponding video information by inputting the electronic tag information via local or network servers.

In accordance with the logistics monitoring and tracking method and system with electronic tag video recording capability of the invention, at the time of video recording, the electronic code information is inserted in the form of electronic tag, and the insertion of electronic tag can satisfy instantaneously the stack of multiple video objects and multiplicity of information. The corresponding real-time video can be retrieved according to the recorded electronic tag, and the electronic tag information can be displayed when the video is replayed. The system supports local server inquiry, network server inquiry, and fuzzy inquiry function. In general, the above-mentioned electronic tag refers to any information encoded by means of electronic coding.

In accordance with the logistics monitoring and tracking method and system with electronic tag video recording capability of the invention, the “watermark” encryption anti-counterfeiting technique and goods identification information video image stacking technology are applied in the digital video, so that the validity and uniqueness of the recorded video image information is accurate and secure. Therefore, the video image information is ensured to be valid, specific, real-time, and practical for the users, and thus can enhance the efficiency of goods identification and increase the accuracy and visual immediacy.

Therefore, the system of the invention can be widely applied in the modern logistics industry, such as in civil transportation of goods, luggage transportation, postal logistics, express deliveries, container transportation, etc, and is applicable to logistics management within large enterprises. With the popularization and improvement of Internet technology, the real-time video image monitoring and tracking of the entire process of goods transportation locally and/or worldwide becomes feasible.

### BRIEF DESCRIPTION OF THE DRAWINGS

FIG. 1 is a schematic diagram of a monitoring and tracking system having electronic tag video recording capability according to one embodiment of the invention;

FIG. 2 is a flow diagram of integrating an electronic tag and a video image code according to one embodiment of the invention;

FIG. 3 is a flow diagram showing decoding of the integrated video image comprising electronic tag information according to one embodiment of the invention;

FIG. 4 is a flow diagram showing retrieving a video image having an electronic tag information associated therewith via a network server according to one embodiment of the invention; and

FIG. 5 is a flow diagram showing inquiring for a video image having electronic tag information associated therewith via a digital video image information storage server according to one embodiment of the invention.

### DETAILED DESCRIPTION OF THE EMBODIMENTS

The invention will hereinafter be described further via the embodiments in combination with the drawings.

The term “electronic tag,” as used herein, refers to a medium constructed by applying electronic coding technology to specific information representing a certain fact or event, or a plurality of facts or events. The term encompasses, without limitation, a barcode, a magnetic strip, an IC card, a radio frequency card, a fingerprint machine, etc. The term is specifically not limited to radio frequency identification (RFID) technology. The “electronic tag” includes not only the tangible objects mentioned above, but also special information capable of representing some processes or events, such as license plate identification, face identification, signal inspection, computer control, etc.

The “electronic tag” of the present invention includes tangible and intangible media in an expression form of an object, or a system, or others. The electronic tag technology is generally applied in the fields of automatic identification technology, automatic control technology, multimedia technology, compressed storage technology, coding technology, network communication technology, signal collection technology, and so on.

Since electronic tags are intrinsically comprised of digital codes and are readable by corresponding equipment or apparatus by utilizing objects as information carrier, such as barcode, magnetic strip, IC card, sensing card, fingerprint machine, computer, etc, they are widely applied in the industries of modern logistics, commercial business, finance, security, anti-counterfeit, transportation toll, staff management, etc. In general, electronic tags are an important mark of modern information society, and are inseparably-connected with our economy and life.

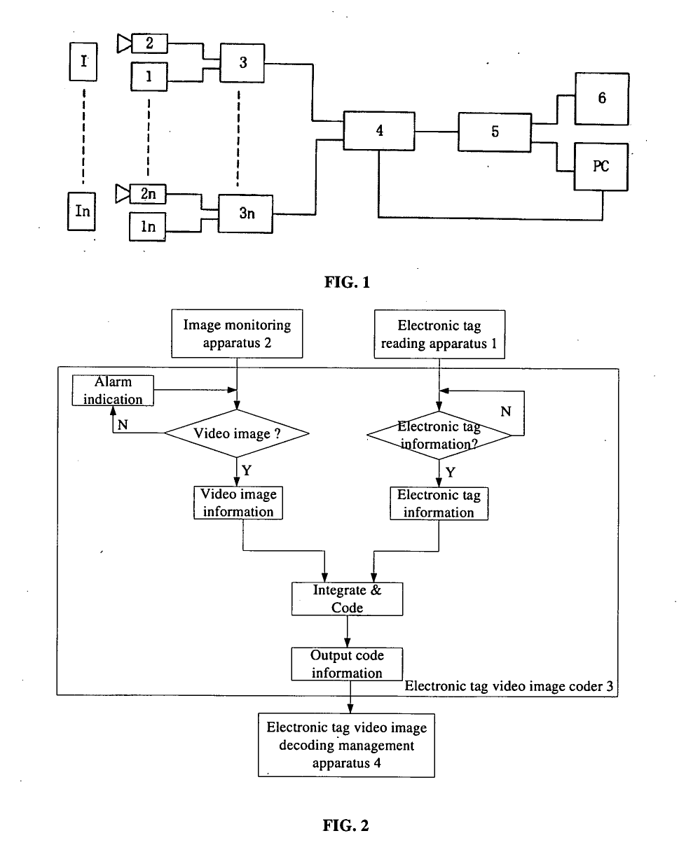

As shown in FIG. 1, a monitoring and tracking system having electronic tag video recording capability comprises a plurality of electronic tag reading apparatuses 1 . . . 1n, a plurality of video image monitoring apparatuses 2 . . . 2n, a plurality of electronic tag video image coders 3 . . . 3n, an electronic tag video image decoding management apparatus 4, a digital video image information storage server 5, a display monitor 6, and a plurality of personal computers (PC). The system can be a multi-channel system containing one or more channels, and can be used for inquiring video images of multiple objects simultaneously.

The electronic tag reading apparatus 1 is a reader or other apparatus capable of identifying electronic tag identification information (such as a barcode or an RFID tag), such as a barcode scanner, an RFID card reader, or a magnetic card reader, or other apparatus for identifying objects via a microprocessor or a computer.

The video image monitoring apparatus 2 is capable of video recording an image of an object (such as parcel post), and is, without limitation, a common industrial, civil or home video camera, X-ray video camera, infrared video camera, etc.

The electronic tag video image coder 3 is capable of integrating and coding the video image recorded by the video image monitoring apparatus 2 and the corresponding electronic tag information output from the electronic tag reading apparatus 1, and storing locally the electronic tag information and output the integrated video image information. The electronic tag video image coder 3 is a multi-purpose information collecting apparatus, and can respond to and read any electronic code as long as the protocol and/or port is standard or public.

The electronic tag video image decoding management apparatus 4 is capable of automatically receiving multi-channel integrated video images having electronic tag information from different electronic tag video image coders 3, and store automatically the tag information after decoding.

Meanwhile, the electronic tag video image decoding management apparatus 4 is also capable of sending the corresponding video image and information to the digital video image information storage server and computer for recording and storage. The electronic tag collecting management apparatus contains multiple communication and associated interfaces, such as RS485, RS232, RS422, UTP, and auxiliary interfaces such as multi-channel I/O input/output ports, one-to-one related video loop distribution output, etc. The electronic tag video image decoding management apparatus 4 can be communicated or associated with other relevant equipment or systems.

The digital video image information storage server 5 is an embedded digital video image storage apparatus, and is capable of real-time storing and pre-recording video image of each channel having electronic tag output from the electronic tag video image decoding management apparatus 4.

The term “video pre-recording,” as used herein, refers to video recording technology capable of predicting an event that is happening or will happen in a short period of time. For example, if an event happens within 1 second, the system can automatically record video images from between 1 second and 30 minutes before and after an event, and can inquire and replay the corresponding video information by inputting the electronic tag information corresponding to an object in question via local or network servers.

The digital video image information storage server 5 can be installed with multiple hard disks.

The display monitor 6 can be a TV monitor, or a VGA monitor. The video image recorded by the system of the invention is a video image having electronic tag information, and can be replayed in real-time in the form of a video, or frame by frame in the form of still video images.

As shown in FIG. 2, the electronic tag reading apparatus 1, the video image monitoring apparatus 2, and the electronic tag video image coder 3 are electronically or electrically connected. Meanwhile, the electronic tag video image coder 3 is capable of detecting automatically the video image monitoring apparatus 2 and the video image monitoring apparatus 2 and indicating, e.g., via audio or visual signals the status of these apparatuses.

After receiving a new electronic tag information, the coder 3 codes and integrates automatically the instantaneous video image at the time the information is generated, and sends the integrated video image information to the electronic tag video image decoding management apparatus 4. The coded and integrated information contains video image information and the corresponding electronic tag information.

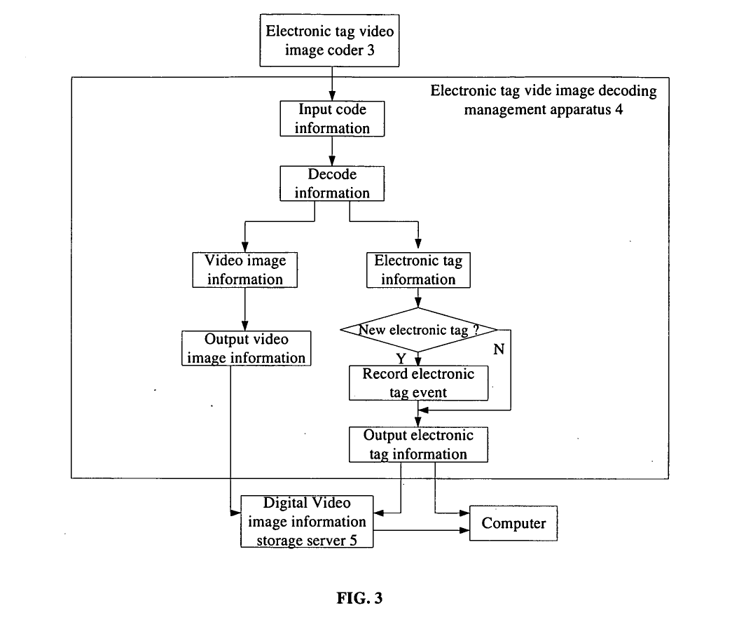

As shown in FIG. 3, decoding of the integrated video image having an electronic tag information comprises:

a) decoding the video image having electronic tag information received from the electronic tag video image coder 3; sending the decoded video image information and electronic tag information to the digital video image information storage server 5 and the computer (PC); and at the same time, recording the electronic tag information in a local server;

b) by remote communication, managing the electronic tag video image coder 3, and assessing whether the electronic tag video image information sent from the electronic tag video image coder 3 is useful or not and whether it is to be recorded and stored; and

c) by remote communication, managing the digital video image information storage server 5, inserting the received real-time electronic tag information into different video channels corresponding to the digital video image information storage server 5, setting the start and end time of video recording of each channel of the digital video image information storage server 5 according to demand.

The system of the invention provides two inquiry methods as described in detail below.

The first method is as shown in FIG. 4, in which a user can inquire through the network by inputting one of the three below-listed inquiry criteria in the provided software: 1) the electronic tag information; 2) the time slot; 3) the channel number and time slot. The system will then start to search and display the corresponding video image files and then replay or backup the corresponding files according to demand.

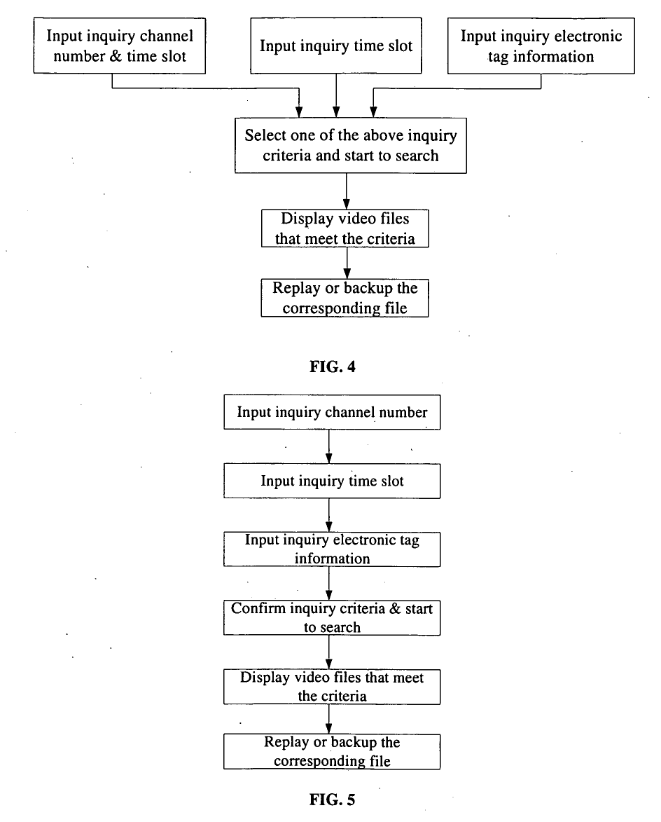

The second method is as shown in FIG. 5, in which a user can inquire through the digital video image information storage server 5 by inputting only the electronic tag number or even incomplete number in a certain time slot. Then, the server can search automatically and replay in real time the corresponding video storage file.

Moreover, the system can pre-record the electronic tag information instantaneously. Namely, the system of the invention can record an entire process (e.g., passage of an object through the system, or through the entire shipping process) starting from several seconds before the process occurs (e.g., an object passes through the system) for processes that occur in a very short time (such as within 1 second or even shorter). The user can himself set the time of video pre-recording before and after each event.

The logistics monitoring and tracking method and system with electronic tag video recording capability of the invention offers automatic video pre-recording capability for events happening in short time frames. The time of the video pre-recording can be set randomly within a range of, e.g., between 1 and 1800 seconds before and after an event.

The logistics monitoring and tracking method and system of the invention is an independent embedded system totally separated from a computer (PC), wherein the digital video image information storage server can be replaced by non-embedded digital hard disk video recording device, which in itself will not change the original function of the system.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

The invention claimed is:

1. A method for monitoring objects comprising the steps of:
a) video recording an object to form a video recording of said object, said object comprising an electronic tag;
b) reading said electronic tag and collecting information contained in said electronic tag;
c) integrating information contained in said electronic tag with said video recording and coding to form an integrated video image; and
d) digitally-storing said integrated video image.

2. The method of claim 1, further comprising decoding said integrated video image to obtain original video recording and information contained in said electronic tag.

3. The method of claim 1, wherein steps a) and b) are carried out simultaneously.

4. The method of claim 1, wherein video recording in step a) is performed by a video camera.

5. The method of claim 1, wherein said object is a package being shipped.

6. The method of claim 1, wherein said electronic tag comprises any information encoded electronically.

7. The method of claim 1, further comprising replaying said integrated video image in a form of a streaming video or in a form of video images frame by frame.

8. The method of claim 1, wherein said video-recording comprises video pre-recording.

9. The method of claim 8, wherein said video pre-recording comprises recording video from between 1 to 1800 seconds before or after an event.

10. A system for monitoring objects comprising
at least one electronic tag reading apparatus for reading an electronic tag and collecting information contained in said electronic tag;
at least one video image monitoring apparatus for video recording an object comprising said electronic tag; and
at least one electronic tag video image coder for integrating information contained in said electronic tag with said video recording and coding to form an integrated video image;
wherein said electronic tag reading apparatus, said video image monitoring apparatus, and said electronic tag video image coder are electrically or electronically connected.

11. The system of claim 10, further comprising an electronic tag video image decoding management apparatus for automatically receiving multi-channel video images having electronic tag information output from said coders and storing automatically said electronic tag information; said electronic tag video image decoding management apparatus being electrically or electronically connected to said electronic tag video image coder.

12. The system of claim 11, wherein said electronic tag video image decoding management apparatus has the function of sending video images and electronic tags to a digital video image information storage server for recording and storage.

13. The system of claim 11, further comprising a digital video image information storage server for real-time storing multi-channel video image information having electronic tags, and for inquiring and replaying a corresponding video information by inputting the electronic tag information via local or network servers; said digital video image information storage server being electrically or electronically connected with said electronic tag video image decoding management apparatus.

14. The system of claim 10, wherein said system does not comprise a personal computer; and said digital video image information storage server is a non-embedded digital hard disk video recording device.

15. The system of claim 10, wherein said video image monitoring apparatus is a video camera.

16. The system of claim 10, wherein said electronic tag comprises any information encoded electronically.

17. The system of claim 10, further comprising a video image display monitor.

18. The system of claim 17, wherein said video image display monitor is a TV monitor or a VGA monitor.
